(19) United States
(12) Patent Application Publication
(10) Pub. No.: US 2010/0233457 A1
(43) Pub. Date: Sep. 16, 2010

(54) FOAM DUSTPROOFING MATERIAL WITH A MICRO CELL STRUCTURE

(75) Inventors: Kazumichi Kato, Osaka (JP); Hiroki Fujii, Osaka (JP); Itsuhiro Hatanaka, Osaka (JP); Takio Itou, Osaka (JP); Shinya Nakano, Osaka (JP); Junji Yoshida, Osaka (JP)

Correspondence Address: EDWARDS ANGELL PALMER & DODGE LLP, P.O. BOX 55874, BOSTON, MA, 02205, US

(73) Assignee: NITTO DENIKO CORPORATION, Ibaraki-shi, Osaka (JP)

(21) Appl. No.: 12/733,660

(22) PCT Filed: Sep. 10, 2008
(86) PCT No.: PCT/JP2008/066342

§ 371 Date: Mar. 12, 2010

(30) Foreign Application Priority Data
Sep. 21, 2007 (JP) 2007-245356

(51) Int. Cl. B32B 5/18; C09K 3/10; B29C 44/34; C08J 9/00

(52) U.S. Cl. 428/220; 428/315.7; 264/50; 264/53

(57) ABSTRACT

To provide a dustproofing material having superior dustproofness and having such superior flexibility as to fit in a further minute clearance typically of 0.10 to 0.20 mm.

Disclosed is a foam dustproofing material which is a dustproofing material including a foam having a thickness of 0.1 to 1.0 mm, in which the foam has a micro cell structure with an average cell diameter of 10 to 65 μm, has such characteristic properties as to give a load against repulsion of from 0.010 to 0.100 MPa upon compression to a thickness of 0.1 mm, and has an apparent density of 0.01 to 0.050 g/cm³. The foam preferably has a closed cell structure or semi-open/semi-closed cell structure. The foam dustproofing material may further include a pressure-sensitive adhesive layer on one or both sides of the foam. The pressure-sensitive adhesive layer is preferably present above the foam through a film layer.

### TECHNICAL FIELD

The present invention relates to a foam dustproofing material and a dustproofing structure using the foam dustproofing material. More specifically, it relates to a foam dustproofing material that has superior dustproofness and can satisfactorily fit even in a minute clearance.

### BACKGROUND ART

Dustproofing materials have been used upon fixation of certain members to predetermined sites (such as fixing parts). Examples of the members include image display members to be fixed to image display devices such as liquid crystal display devices, electroluminescent display devices, and plasma display devices; and optical members such as cameras and lenses to be fixed typically to so-called “cellular phones” and “personal digital assistants”. Examples of such dustproofing materials generally used include micro cell urethane foams having low expansion ratios and having closed cell structures; compressed molded articles obtained from highly expanded urethane foams; and polyethylene foams having expansion ratios of about 30. Specifically, there have been used a gasket including a polyurethane foam having a density of from 0.3 to 0.5 g/cm³ (see Patent Document 1) and a sealing material for electric/electronic appliances, including a foamed structure having an average cell diameter of from 1 to 500 μm (see Patent Document 2).

The use of such known dustproofing materials has not required large decompression, because clearances in portions where the dustproofing materials are used have been sufficiently large in common image display members mounted to image display devices such as liquid crystal display devices, electroluminescent display devices, and plasma display devices; and in optical members such as cameras and lenses mounted to so-called “cellular phones” and “personal digital assistants”. Accordingly, there has required no particular consideration on repulsive force of such dustproofing materials against compression.

However, products to which optical members (e.g., image display devices, cameras, and lenses) are mounted have been slimed and slimed, and dustproofing materials should be used in clearances which have become smaller and smaller. In addition, it becomes difficult to use some of the commonly used dustproofing materials because of their large repulsive force. Demands are therefore made to provide a dustproofing material which can exhibit superior dustproofness and has such superior flexibility as to fit even in a minute clearance.

The gasket disclosed in Patent Document 1, i.e., the gasket including a polyurethane foam having a density of from 0.3 to 0.5 g/cm³, is designed to prevent the rattling of a liquid crystal display screen but shows insufficient flexibility and cushioning properties.

The technique relating to the sealing material for electric/electronic appliances disclosed in Patent Document 2, i.e., the sealing material for electric/electronic appliances including a foamed structure having an average cell diameter of from 1 to 500 μm, does not refer to the repulsive force against compression if used as a foam material.

Independently, Japanese Unexamined Patent Application Publication (JP-A) No. 2005-97566 (Patent Document 3) discloses a technique which provides a dustproofing material having superior dustproofness and showing such superior flexibility as to follow or fit even in a minute clearance, and also discloses a dustproofing structure using the dustproofing material. The dustproofing material and dustproofing structure, however, are still insufficient in flexibility and cushioning properties when applied into a further minute clearance of from 0.10 to 0.20 mm.

Patent Document 1: Japanese Unexamined Patent Application Publication (JP-A) No. 2001-100216

Patent Document 2: Japanese Unexamined Patent Application Publication (JP-A) No. 2002-309198

Patent Document 3: Japanese Unexamined Patent Application Publication (JP-A) No. 2005-97566

### DISCLOSURE OF INVENTION

### Problems to be Solved by the Invention

Accordingly an object of the present invention is to provide a dustproofing material which has superior dustproofness and shows such superior flexibility as to fit even in a further minute clearance typically of from 0.10 to 0.20 mm.

Independently, a common dustproofing material, when affixed to a slightly adhesive single-sided pressure-sensitive adhesive tape, should be subjected to a heat treatment to increase the adhesive strength with the slightly adhesive single-sided pressure-sensitive adhesive tape.

Another object of the present invention is therefore to provide a dustproofing material which has a micro cell structure, thereby has an improved adhesion (adhesive strength) with a slightly adhesive single-sided pressure-sensitive adhesive tape, and does not need a heat treatment step to increase the adhesive strength with the slightly adhesive single-sided pressure-sensitive adhesive tape.

Additionally, such a foam member (foam material) should have a sufficient adhesive strength with a carrier tape for foam member so as to be securely held by the carrier tape during conveyance and during punching.

Still another object of the present invention is therefore to provide a dustproofing material (foam member) which has a micro cell structure, thereby has improved adhesion with a carrier tape, and is prevented from displacement or slippage during conveyance or punching. Yet another object of the present invention is to provide a dustproofing material which exhibits sufficient initial adhesion with a carrier tape.

### Means for Solving the Problems

After intensive investigations to achieve the above objects, the present inventors have found that a dustproofing material can exhibit superior dustproofness and can satisfactorily fit even in a minute clearance by using, as a foam constituting the dustproofing material, a specific foam. This foam has a thickness of from 0.1 to 1.0 mm, has a micro cell structure with an average cell diameter of from 10 to 65 μm, having such characteristic properties as to give a load against repulsion of from 0.010 to 0.100 MPa upon compression to a thickness of from 0.1 to 0.2 mm, and has an apparent density of from 0.01 to 0.05 g/cm³. The present invention has been made based on these findings.

Specifically, the present invention provides, in an embodiment, a foam dustproofing material which includes a foam having a thickness of from 0.1 to 1.0 mm. The foam has a micro cell structure with an average cell diameter of from 10 to 65 μm, has such characteristic properties as to give a load against repulsion of from 0.010 to 0.100 MPa upon compression to a thickness of 0.1 mm, and has an apparent density of from 0.01 to 0.050 g/cm³.

The average cell diameter of the foam is preferably from 10 to 50 μm.

The foam preferably has a closed cell structure or semi-open/semi-closed cell structure. The foam dustproofing material may further include a pressure-sensitive adhesive layer present on or above one or both sides of the foam, and the pressure-sensitive adhesive layer is preferably present above one or both sides of the foam with the interposition of a film layer. The pressure-sensitive adhesive layer may include an acrylic pressure-sensitive adhesive.

The foam is preferably prepared through the steps of impregnating a thermoplastic polymer with a high-pressure inert gas and subjecting the impregnated thermoplastic polymer to decompression. The foam may be prepared through the steps of impregnating an unfoamed molded article comprised of a thermoplastic polymer with a high-pressure inert gas and subjecting the impregnated unfoamed molded article to decompression; or may be prepared through the steps of impregnating a molten thermoplastic polymer with an inert gas under a pressure (under a load) and subjecting the impregnated thermoplastic polymer simultaneously to decompression and molding (forming). The foam is preferably prepared further through heating after the decompression.

The inert gas is preferably carbon dioxide. The inert gas is preferably in a supercritical state during impregnation.

In another embodiment, the present invention provides a foam dustproofing material (foam dustproofing member) which includes a sliced piece of the foam dustproofing material and has a thickness of from 0.2 to 0.4 mm.

### ADVANTAGES

The foam dustproofing materials according to embodiments of the present invention have the above configurations, thereby have superior dustproofness, and show such superior flexibility as to fit even in a minute clearance typically of from 0.10 to 0.20 mm.

The foam dustproofing materials, as having the above configurations, can have improved adhesiveness with a single-sided pressure-sensitive adhesive tape and with a carrier tape.

### BRIEF DESCRIPTION OF DRAWINGS

FIG. 1 is a schematic diagram showing an exemplary dustproofness-testing apparatus.

FIG. 2 is a schematic cross-sectional view showing how to rate fittability in clearance.

### REFERENCE NUMERALS

1a schematic structure of dustproofness-testing apparatus
1b schematic sectional structure of dustproofness-testing apparatus
11 ceiling panel
12 spacer
13 double-sided pressure-sensitive adhesive tape
14 foam
15 testing box
16a through hole
16b through hole
16c through hole
17 opening
18 space
2 jig for rating of fittability in clearance
21a acrylic plate 10 mm thick
21b acrylic plate 20 mm thick
22 spacer 0.1 mm thick
23 foam
a loading direction

### BEST MODES FOR CARRYING OUT THE INVENTION

### Foam Constituting Foam Dustproofing Material

A foam dustproofing material [dustproofing material (sealant) including a foam] according to an embodiment of the present invention includes a foam having a thickness of from 0.1 to 1.0 mm, in which the foam has a micro cell structure with an average cell diameter of from 10 to 65 μm, has such characteristic properties as to give a load against repulsion of from 0.010 to 0.100 MPa upon compression to a thickness of 0.1 mm, and has an apparent density of from 0.01 to 0.050 g/cm³. The foam dustproofing material can have higher dustproofness and more satisfactory light blocking properties by controlling the average cell diameter of the foam in its upper limit to 65 μm or less. The average cell diameter is preferably 50 μm or less, more preferably 40 μm or less, and furthermore preferably 30 μm or less. The foam dustproofing material can have more satisfactory cushioning properties (shock absorbing properties) by controlling the average cell diameter of the foam in its lower limit to 10 μm or more. The average cell diameter is preferably 15 μm or more, and more preferably 20 μm or more.

Even when adopted in a narrow clearance, the foam dustproofing material does not suffer from defects or troubles due to repulsion, because the load against repulsion upon compression to a thickness of 0.1 mm (repulsive force upon compression to a thickness of 0.1 mm) of the foam is controlled in its upper limit to 0.100 MPa or less. The load against repulsion is preferably 0.080 MPa or less, and more preferably 0.050 MPa or less. On the other hand, the foam dustproofing material can reliably have superior dustproofness, because the load against repulsion of the foam upon compression to a thickness of 0.1 mm is controlled in its lower limit to 0.010 MPa or more. The load against repulsion is preferably 0.015 MPa or more, and more preferably 0.020 MPa or more.

The thickness of the foam constituting the dustproofing material is generally from 0.1 to 1.0 mm and preferably from 0.2 to 0.5 mm. The foam, if having a thickness of more than 1.0 mm, may have an excessively large load against repulsion upon compression to 0.1 mm; and the foam, if having a thickness of less than 0.1 mm, may not help the foam dustproofing material to have sufficient dustproofness.

The foam dustproofing material can have increased flexibility by controlling the apparent density of the foam in its upper limit to 0.05 g/cm³ or less. The apparent density preferably 0.04 g/cm³ or less. The foam dustproofing material can have ensured superior dustproofness by controlling the apparent density of the foam in its lower limit to 0.01 g/cm³ or more. The apparent density is preferably 0.02 g/cm³ or more.

The foam is not limited in its composition, cell structure, and other conditions, as long as having the characteristic properties. The foam, however, preferably has a closed cell structure or semi-open/semi-closed cell structure as its cell structure. The semi-open/semi-closed cell structure is a cell structure in which a closed cell structure and an open cell structure are present in coexistence, and the ratio between the two structures is not limited. The foam more preferably has such a cell structure that the closed cell structure occupies 80% or more, and furthermore preferably 90% or more, of the entire structure of the foam.

A foam in a foam dustproofing material according to an embodiment of the present invention can be prepared according to a technique generally employed in expansion molding (foam molding), such as a physical technique or chemical technique. An exemplary regular physical technique is a technique in which a low-boiling liquid (blowing agent), such as a chlorofluorocarbon or a hydrocarbon, is dispersed in a polymer, and the polymer bearing the blowing agent is heated to volatilize the blowing agent to thereby form bubbles (cells). The chemical technique is a technique in which a compound (blowing agent) is added to a polymer base, and the blowing agent in the polymer base is thermally decomposed to evolve a gas to thereby form cells, thus obtaining a foam. Of these techniques, the physical technique is preferred in consideration typically of recent environmental issues.

Exemplary processes for the preparation of the foam include a process in which constituents such as a natural rubber or synthetic rubber (e.g., chloroprene rubber, ethylene, propylene, or a terpolymer), a vulcanizing agent, a blowing agent, and a filler are kneaded in a kneading machine such as a Banbury mixer or press kneader, and the kneaded article is formed into a sheet or rod typically through calendering, extrusion with an extruder, or conveyer belt casting while continuously kneading, and the molded article is heated to carry out vulcanization and foaming, and, where necessary, the vulcanized foam is cut into a predetermined shape; and a process in which constituents such as a natural rubber or synthetic rubber, a vulcanizing agent, a blowing agent, and a filler are kneaded using mixing rolls, and the kneaded composition is subjected to vulcanization, foaming, and molding all in a mold according to a batch system.

The foam herein is preferably prepared by a process using a high-pressure inert gas as a blowing agent, because this gives a foam having a small cell diameter and a high cell density. Typically, the foam is preferably prepared by a process through the steps of impregnating a thermoplastic polymer with a high-pressure inert gas, and subjecting the impregnated thermoplastic polymer to decompression to give a foam. The blowing agent is especially preferably carbon dioxide so as to give a clean foam with little impurities. If foaming is performed according to the common physical technique as above, there may occur problems about the combustibility, toxicity, and influence on the environment (such as ozone layer depletion) of the substance used as the blowing agent. If foaming is performed according to the common chemical technique, the residue of the blowing gas remains in the foam. This causes problems such as corrosion by the corrosive gas, if the blowing agent is corrosive, and contamination by impurities in the gas, and these troubles are significant especially in electronic appliances where suppression of contamination is highly needed. In addition, the common physical and chemical foaming techniques are believed to be difficult to give a micro cell structure and to be very difficult to give micro bubbles (micro cells) of 300 μm or less

As has been mentioned above, the foam for use herein is preferably prepared by a process using a high-pressure inert gas as a blowing agent. Typically, an advantageous process is a process of preparing a foam through the steps of impregnating a thermoplastic polymer with a high-pressure inert gas, and subjecting the impregnated thermoplastic polymer to decompression. In the impregnation with an inert gas, an unfoamed molded article which has been molded may be impregnated with the inert gas, or a molten thermoplastic polymer may be impregnated with the inert gas under a pressure (under a load). Accordingly, exemplary preferred processes for preparing a foam include a process of forming a foam through the steps of impregnating a thermoplastic polymer with a high-pressure inert gas, and subjecting the impregnated thermoplastic polymer to decompression; a process of forming a foam through the steps of impregnating an unfoamed molded article including a thermoplastic polymer with a high-pressure inert gas, and subjecting the impregnated unfoamed molded article to decompression; and a process of forming a foam through the steps of impregnating a molten thermoplastic polymer with an inert gas under a pressure (under a load), and subjecting the impregnated molten thermoplastic polymer simultaneously to decompression and molding (forming).

(Thermoplastic Polymer)

A thermoplastic polymer for constituting the foam (resin foam) herein is not especially limited, as long as being polymer having thermoplasticity and capable of impregnating with a high-pressure gas. Exemplary thermoplastic polymers herein include olefinic polymers such as low-density polyethylenes, medium-density polyethylenes, high-density polyethylenes, linear low-density polyethylenes, polypropylenes, copolymers of ethylene and propylene, copolymers of ethylene or propylene with another α-olefin, and copolymers of ethylene and another ethylenically unsaturated monomer (e.g., vinyl acetate, acrylic acid, an acrylic ester, methacrylic acid, methacrylic ester, or vinyl alcohol); styrenic polymers such as polystyrenes and acrylonitrile-butadiene-styrene copolymers (ABS resins); polyamides such as 6-nylon, 66-nylon, and 12-nylon; polyamideimides; polyurethanes; polyimides; polyetherimides; acrylic resins such as poly(methyl methacrylate)s; poly(vinyl chloride)s; poly(vinyl fluoride)s; alkenyl-aromatic resins; polyesters such as poly(ethylene terephthalate)s and poly(butylene terephthalate)s; polycarbonates such as bisphenol-A polycarbonates; polyacetals; and poly(phenylene sulfide)s.

Exemplary thermoplastic polymers further include thermoplastic elastomers that show properties as rubber at ordinary temperature (room temperature) but show thermoplasticity at high temperatures. Exemplary thermoplastic elastomers include olefinic elastomers such as ethylene-propylene copolymers, ethylene-propylene-diene copolymers, ethylene-vinyl acetate copolymers, polybutenes, polyisobutylenes, and chlorinated polyethylenes; styrenic elastomers such as styrene-butadiene-styrene copolymers, styrene-isoprene-styrene copolymers, and styrene-isoprene-butadiene-styrene copolymers, and hydrogenated polymers derived from them; thermoplastic polyester elastomers; thermoplastic polyurethane elastomers; and thermoplastic acrylic elastomers. These thermoplastic elastomers have advantageous properties such as glass transition temperatures of room temperature or lower (e.g., 20° C. or lower) and, when formed into dustproofing materials or sealants, exhibit remarkably excellent flexibility and can remarkably satisfactorily fit in or match the dimensions of an article to be applied.

Each of different thermoplastic polymers can be used alone or in combination. The material (thermoplastic polymer) for constituting the foam can be any selected from one or more thermoplastic elastomers; one or more thermoplastic polymers other than thermoplastic elastomers; and mixtures of one or more thermoplastic elastomers with one or more thermoplastic polymers other than thermoplastic elastomers.

Exemplary mixtures of one or more thermoplastic elastomers with one or more thermoplastic polymers other than thermoplastic elastomers include a mixture of one or more olefinic elastomers such as ethylene-propylene copolymers, with one or more olefinic polymers such as polypropylenes. The ratio of one or more thermoplastic elastomers to one or more thermoplastic polymers other than thermoplastic elastomers in a mixture of them, if adopted, is typically from about 1:99 to about 99:1, preferably from about 10:90 to about 90:10, and more preferably from about 20:80 to about 80:20.

(Inert Gas)

An inert gas for use herein is not especially limited, as long as being inert to the thermoplastic polymer and being impregnatable into the thermoplastic polymer. Exemplary inert gases include carbon dioxide, nitrogen gas, and air. These gases may be used in combination as a mixture. Of these, carbon dioxide is preferred, because it can be impregnated in a large amount and at a high rate into the thermoplastic polymer to be used as a material for constituting the foam.

The inert gas is preferably in a supercritical state upon impregnation of the thermoplastic polymer. Such an inert gas in a supercritical state shows increased solubility in the thermoplastic polymer and can be incorporated therein in a higher concentration. In addition, because of its high concentration, the supercritical inert gas generates a larger number of cell nuclei upon an abrupt pressure drop (decompression) after impregnation. These cell nuclei grow to give cells which are present in a higher density than in a foam having the same porosity but prepared with the same gas but in another state. Consequently, use of a supercritical inert gas can give fine micro cells. The critical temperature and critical pressure of carbon dioxide are 31° C. and 7.4 MPa, respectively.

The thermoplastic polymer may be incorporated with one or more additives according to necessity upon the formation of the foam. Such additives are not limited in their types and can be additives generally used in expansion molding (foaming molding). Exemplary additives usable herein include foaming nucleators, crystal nucleators, plasticizers, lubricants, colorants (e.g., pigments and dyestuffs), ultraviolet absorbers, antioxidants, age inhibitors, fillers, reinforcements, flame retardants, antistatic agents, surfactants, vulcanizing agents, and surface-treating agents. The amounts of additives can be chosen within ranges not impeding, for example, the formation of bubbles (cells) and can be such amounts as commonly used in the molding of thermoplastic polymers such as thermoplastic elastomers. Each of different additives can be used alone or in combination.

The lubricants help to improve the fluidity of the thermoplastic polymer and to suppress the thermal degradation of the polymer. Such lubricants for use herein are not especially limited, as long as helping the thermoplastic polymer to have higher fluidity. Exemplary lubricants include hydrocarbon lubricants such as liquid paraffins, paraffin waxes, microcrystalline waxes, and polyethylene waxes; fatty acid lubricants such as stearic acid, behenic acid, and 12-hydroxystearic acid; and ester lubricants such as butyl stearate, stearic acid monoglyceride, pentaerythritol tetrastearate, hydrogenated caster oil, and stearyl stearate. Each of different lubricants can be used alone or in combination.

The amount of lubricants is, for example, from 0.5 to 10 parts by weight, preferably from 0.8 to 8 parts by weight, and more preferably from 1 to 6 parts by weight, per 100 parts by weight of the thermoplastic polymer. Lubricants, if added in an amount of more than 10 parts by weight, may cause excessively high fluidity of the thermoplastic polymer, and this may lower the expansion ratio. Lubricants, if added in an amount of less than 0.5 part by weight, may not sufficiently help to improve the fluidity of the polymer, and the thermoplastic polymer may not sufficiently expand upon foaming (blowing), thus resulting in a lower expansion ratio.

The shrinkage inhibitors help to form molecular films (monolayers) on surfaces of cell membranes (cell walls) of the foam to effectively block the permeation of the blowing agent gas. Such shrinkage inhibitors for use herein are not especially limited, as long as having the function of blocking the permeation of the blowing agent gas. The shrinkage inhibitors can be any of metal salts of fatty acids and fatty amides. Exemplary metal salts of fatty acids include aluminum, calcium, magnesium, lithium, barium, zinc, and lead salts of fatty acids such as stearic acid, behenic acid, and 12-hydroxystearic acid. Exemplary fatty amides include fatty amides whose fatty acid moiety having about 12 to about 38 carbon atoms (preferably having about 12 to about 22 carbon atoms), such as stearamide, oleamide, erucamide, methylene bis(stearamide), ethylene bis(stearamide), and lauric bisamide. Such fatty amides may be either monoamides and bisamides, but bisamides are preferred for giving a micro cell structure. Each of different shrinkage inhibitors can be used alone or in combination.

The amount of shrinkage inhibitors is, for example, from 0.5 to 10 parts by weight, preferably from 0.7 to 8 parts by weight, and more preferably from 1 to 6 parts by weight, per 100 parts by weight of the thermoplastic polymer. Shrinkage inhibitors, if added in an amount of more than 10 parts by weight, may lower gas efficiency during cell growth process, and the resulting foam may include a large quantity of unfoamed portions and may expand at an insufficient expansion ratio, although it includes cells with small diameters. Shrinkage inhibitors, if added in an amount less than 0.5 part by weight, may not sufficiently help to form films over cell walls, and this may cause gas escape during foaming and cause shrinkage of the resulting foam, thus resulting in an insufficient expansion ratio of the foam.

Though not especially limited, the lubricants and the shrinkage inhibitors may be used in combination as additives. Typically, one or more lubricants such as stearic acid monoglyceride may be used in combination with one or more shrinkage inhibitors such as erucamide and lauric bisamide.

(Preparation of Foam)

Exemplary processes for forming a foam through impregnation of a thermoplastic polymer with a high-pressure inert gas include a process for forming a foam through the steps of impregnating a thermoplastic polymer with an inert gas under a high pressure (gas impregnation step); reducing the pressure after the gas impregnation step so as to allow the resin to expand (decompression step); and, where necessary, heating the expanded resin to allow cells to grow (heating step). In this process, an unfoamed molded article which has been molded in advance may be impregnated with an inert gas, or a molten thermoplastic polymer may be impregnated with an inert gas under a pressure and the impregnated molten thermoplastic polymer may be subjected to molding during decompression, as described above. These steps may be carried out according to a batch system or continuous system.

According to a batch system, the foam may be prepared, for example, in the following manner. Initially, an unfoamed molded article (e.g., a resin sheet for the formation of foam) is formed by extruding a thermoplastic polymer such as a polyolefin resin or thermoplastic elastomer through an extruder such as a single-screw extruder or twin-screw extruder. Alternatively, such an unfoamed molded article (e.g., a resin sheet for the formation of foam) including a thermoplastic polymer as a base resin is formed by uniformly kneading a thermoplastic polymer such as a polyolefin resin or thermoplastic elastomer with a kneading machine equipped with one or more blades typically of roller, cam, kneader, or Banbury type; and press-forming the kneadate with a hot-plate press. The resulting unfoamed molded article is placed in a pressure-tight vessel, a high-pressure inert gas is injected into the vessel, and the unfoamed molded article is impregnated with the inert gas. In this case, the unfoamed molded article is not especially limited in shape and can be in any form such as a roll form or sheet form. The injection of the high-pressure inert gas can be performed continuously or discontinuously. At the time when the unfoamed molded article has been sufficiently impregnated with the high-pressure inert gas, the unfoamed molded article is released from the pressure (the pressure is usually lowered to atmospheric pressure) to thereby generate cell nuclei in the base resin. The cell nuclei may be allowed to grow at room temperature without heating or may be allowed to grow by heating according to necessity. The heating can be performed according to a known or common procedure such as heating with a water bath, oil bath, hot roll, hot-air oven, far-infrared rays, near-infrared rays, or microwaves. After the cells are allowed to grow in the above manner, the article is rapidly cooled typically with cold water to fix its shape.

According to a continuous system, a foam may be formed, for example, in the following manner. Specifically, a thermoplastic polymer is kneaded with an extruder such as a single-screw extruder or twin-screw extruder, and during the kneading, a high-pressure inert gas is injected so as to impregnate the thermoplastic polymer with the gas sufficiently. The resulting article is then extruded and thereby released from the pressure (the pressure is usually lowered to atmospheric pressure) to perform expansion and molding simultaneously to thereby allow cells to grow. In some cases, heating is performed to assist the growth of cells. After cells are thus allowed to grow, the extrudate is rapidly cooled typically with cold water to fix its shape.

The pressure in the gas impregnation step is, for example, 6 MPa or more (e.g., from about 6 to about 100 MPa), and preferably 8 MPa or more (e.g., from about 8 to about 100 MPa). If the pressure of the inert gas is lower than 6 MPa, considerable cell growth may occur during foaming, and this may cause the cells to have too large diameters to give a small average cell diameter within the above-specified range and may cause insufficient dustproofing effects. The reasons for this are as follows. When impregnation is performed under a low pressure, the amount of the gas impregnated is relatively small and the cell nuclei grow at a lower rate as compared with impregnation under a higher pressure. As a result, the number of formed cell nuclei is smaller. Because of this, the gas amount per cell increases rather than decreases, resulting in excessively large cell diameters. Furthermore, under pressures lower than 6 MPa, only a slight change in impregnation pressure results in considerable changes in cell diameter and cell density, and this may often impede the control of cell diameter and cell density.

The temperature in the gas impregnation step may vary depending typically on the types of the inert gas and thermoplastic polymer to be used and can be chosen within a wide range. When impregnation operability and other conditions are taken into account, the impregnation temperature is, for example, from about 10° C. to about 350° C. For example, when an unfoamed molded article typically in a sheet form is impregnated with an inert gas according to a batch system, the impregnation temperature is from about 10° C. to 200° C., and preferably from about 40° C. to about 200° C. When a molten polymer is impregnated with a gas and is extruded to perform foaming (expansion) and molding simultaneously according to a continuous system, the impregnation temperature is generally from about 60° C. to about 350° C. When carbon dioxide is used as the inert gas, the impregnation temperature is preferably 32° C. or higher, and more preferably 40° C. or higher in order to keep carbon oxide in a supercritical state.

Though not critical, the decompression rate in the decompression step is preferably from about 5 to about 300 MPa per second from the viewpoint of obtaining uniform fine cells. The heating temperature in the heating step is, for example, from about 40° C. to about 250° C., and preferably from about 60° C. to about 250° C.

The average cell diameter (average cell size), load against repulsion upon compression to a thickness of 0.1 mm (repulsive force upon compression to a thickness of 0.1 mm), and apparent density can be controlled by suitably choosing and setting conditions and parameters according typically to the types of the inert gas, and of the thermoplastic polymers such as thermoplastic elastomers to be used, and of the additives to be used. Exemplary conditions and parameters include operational conditions, such as temperature, pressure, and time (duration) in the gas impregnation step; operational conditions, such as decompression rate, temperature, and pressure, in the decompression step; and the temperature of heating performed after the decompression.

[Foam Dustproofing Materials]

A foam dustproofing material (foam dustproofing member; foam sealant) according to an embodiment of the present invention includes a foam having specific characteristic properties as above. The foam dustproofing material can be a foam dustproofing material effectively exhibiting its functions even when including the foam alone. The foam dustproofing material may also be a foam dustproofing material further including another layer or carrier (substrate) present on or above one or both sides of the foam. Of such other layers and carriers, a pressure-sensitive adhesive layer is preferred. Typically, the foam dustproofing material, when further including a pressure-sensitive adhesive layer on one or both sides of the foam, has the function of fixing or temporally fixing a member or part, such as an optical member, to an adherend. The foam dustproofing material according to the present invention preferably further includes a pressure-sensitive adhesive layer on or above at least one side (one or both sides) of the foam constituting the foam dustproofing material.

A pressure-sensitive adhesive for constituting the pressure-sensitive adhesive layer is not especially limited and can be suitably chosen from among known pressure-sensitive adhesives such as acrylic pressure-sensitive adhesives, rubber pressure-sensitive adhesives (e.g., natural rubber pressure-sensitive adhesives and synthetic rubber pressure-sensitive adhesives), silicone pressure-sensitive adhesives, polyester pressure-sensitive adhesives, urethane pressure-sensitive adhesives, polyamide pressure-sensitive adhesives, epoxy pressure-sensitive adhesives, vinyl alkyl ether pressure-sensitive adhesives, and fluorine-containing pressure-sensitive adhesives. The pressure-sensitive adhesives may be hot-melt pressure-sensitive adhesives. Each of different pressure-sensitive adhesives can be used alone or in combination. The pressure-sensitive adhesives may also be pressure-sensitive adhesives of any type, such as emulsion pressure-sensitive adhesives, solvent-based pressure-sensitive adhesives, oligomer pressure-sensitive adhesives, and solid pressure-sensitive adhesives.

The pressure-sensitive adhesive for use herein is preferably an acrylic pressure-sensitive adhesive from the viewpoints typically of preventing contamination of the adherend.

The pressure-sensitive adhesive layer can be formed according to a known or common process. Exemplary formation processes include a coating process in which a pressure-sensitive adhesive is applied to a predetermined site or surface to form a pressure-sensitive adhesive layer thereon; and a transfer process in which a pressure-sensitive adhesive is applied to a release film, such as a release liner, to form a pressure-sensitive adhesive layer thereon, and the pressure-sensitive adhesive layer is transferred to a predetermined site or surface. The formation of the pressure-sensitive adhesive layer can be performed by suitably using a known or common coating procedure such as flow casting, coating with a roll coater, coating with a reverse coater, or coating with a doctor blade.

The thickness of the pressure-sensitive adhesive layer is generally from about 2 to about 100 μm, and preferably from about 10 to about 100 μm. The thickness of the pressure-sensitive adhesive layer is preferably small, because such a thin pressure-sensitive adhesive layer can be more effectively prevented from the attachment of dirt or dust at the edges thereof. The pressure-sensitive adhesive layer may have a single-layer structure or multilayer structure.

The pressure-sensitive adhesive layer may be present above the foam with the interposition of one or more other layers (underlayers). Exemplary underlayers include carrier layers (of which film layers are preferred); other pressure-sensitive adhesive layers; intermediate layers; and under coats.

When the pressure-sensitive adhesive layer is present on or above only one side of the foam, one or more other layers may be present on the other side of the foam. Exemplary other layers herein include pressure-sensitive adhesive layers of other types; and carrier layers.

The shape and thickness of the foam dustproofing material according to the present invention are not especially limited and can be suitably chosen according typically to the intended use. However, the thicknesses of the foam dustproofing materials are desirably chosen within ranges of from about 0.1 to about 1.0 mm, preferably from about 0.2 to about 0.5 mm, and more preferably from about 0.3 to about 0.4 mm, from the viewpoint of obtaining such superior flexibility as to fit even in a further minute clearance typically of from 0.10 to 0.20 mm.

The foam dustproofing materials and the foams constituting the foam dustproofing materials may have been subjected to processing so as to have desired shapes and thicknesses. Typically, a foam dustproofing material having a desired thickness can be obtained by slicing the foam dustproofing material. More specifically but by way of example, a foam dustproofing material having a thickness of from 0.2 to 0.4 mm can be obtained by slicing a foam dustproofing material having a thickness of more than 0.4 mm.

Products of such foam dustproofing materials are generally obtained by processing the foam dustproofing materials into various shapes matching devices to which they are adopted.

The foam dustproofing materials according to embodiments of the present invention have the above-mentioned characteristic properties, have very fine cells, have low loads against repulsion upon compression to a thickness of 0.1 mm (repulsive force upon compression to a thickness of 0.1 mm) to show satisfactory flexibility, and have low apparent densities. Specifically, they can exhibit such superior flexibility as to fit even in a minute clearance while maintaining their cell diameters (cell sizes) being small, and can thereby satisfactorily fit even in a further minute clearance while maintaining dustproofness intrinsically required. In addition, they show high expansion ratios and are light-weighed.

In a preferred embodiment, the foam constituting the foam dustproofing material is prepared from a thermoplastic polymer (e.g., a thermoplastic elastomer) using an inert gas (e.g., carbon dioxide) as a blowing agent. The resulting foam dustproofing material further excels in flexibility through the use of the thermoplastic polymer and, in addition, it is clean without the generation of harmful substances and remaining of contaminants, in contrast to one prepared according to a common physical foaming technique or common chemical foaming technique, because the foam is prepared by using the inert gas. The foam dustproofing material is therefore especially advantageously used also as a dustproofing material for use typically in electronic appliances.

Such foam dustproofing materials according to embodiments of the present invention are useful as dustproofing materials adopted in mounting (installation) of various members or parts (such as optical members) to predetermined sites. The foam dustproofing materials are particularly advantageously adopted to the fixing (mounting) of small-sized members or parts (such as small-sized optical members) into slimmed products.

Exemplary optical members that can be mounted (installed) through the foam dustproofing materials include image display members (of which small-sized image display members are preferred) to be mounted to image display devices such as liquid crystal display devices, electroluminescent display devices, and plasma display devices; and cameras and lenses (of which small-sized cameras and lenses are preferred) to be mounted to mobile communication devices such as so-called “cellular phones” and “personal digital assistants”.

The foam dustproofing materials according to embodiments of the present invention can also be used as dustproofing materials to prevent toners from leaking from toner cartridges.

(Structure Including Optical Member)

According to another embodiment of the present invention, there is provided a structure including an optical member. In this structure, the optical member is mounted to a predetermined site. More specifically, the optical member is mounted (installed) to a predetermined site through any of the foam dustproofing materials in this structure. Examples of the structure include image display devices such as liquid crystal display devices, electroluminescent display devices, and plasma display devices, of which image display devices in which small-sized image display members are mounted as optical members are preferred; and mobile communication devices such as so-called “cellular phones” and “personal digital assistants” in which cameras and/or lenses are mounted as optical members, of which mobile communication devices in which small-sized cameras or lenses are mounted as optical members are preferred. The structure may be a slimed product as compared to common products, and the thickness and shape of the structure are not critical herein.

(Dustproofing Structure)

According still another embodiment of the present invention, there is provided a dustproofing structure which is adopted in mounting of an optical member to a predetermined site. The dustproofing structure has a structure in which the optical member is mounted through any of the foam dustproofing materials. The dustproofing structure is not especially structurally limited, as long as the foam dustproofing material is used in mounting (installation) of an optical member to a predetermined site. Accordingly, the optical member and the predetermined site to which the optical member is mounted are not especially limited and can be chosen suitably. For example, exemplary optical members herein include the above-mentioned optical members.

### EXAMPLES

The present invention will be illustrated in further detail with reference to several examples below. It should be noted, however, that these examples are never construed to limit the scope of the present invention. The average cell diameters (average cell sizes) and apparent densities of foams were determined according to the following methods.

(Average Cell Diameter)

The average cell diameter (μm) of a sample foam was determined by capturing an enlarged image of a cellular portion of the foam using a digital microscope (trade name “VHX-500” supplied by Keyence Corporation); and analyzing the captured image through an image analysis software (trade name “Win ROOF” supplied by Mitani Corporation).

(Apparent Density)

A sample foam was punched with a punch die (press knife) 100 mm wide and 100 mm long, and the dimensions of the punched sample were measured. Independently, the thickness of the sample was measured with a 1/100 scaled dial gauge having a measuring terminal 20 mm in diameter (φ). The volume of the foam was calculated from these data.

Next, the weight of the foam was measured with an even balance having a minimum scale of 0.01 g or more. The apparent density (g/cm³) of the foam was calculated from these data.

### Example 1

In a twin-screw kneader supplied by The Japan Steel Works, LTD. (JSW) were kneaded, at a temperature of 200° C., 45 parts by weight of a polypropylene [melt flow rate (MFR): 0.35 gram per 10 minutes], 55 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), 1 part by weight of stearic acid monoglyceride, and 1 part by weight of a fatty amide (lauric acid bisamide). The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 40 μm and an apparent density of 0.03 g/cm³.

### Example 2

In a twin-screw kneader supplied by The Japan Steel Works, LTD. (JSW) were kneaded, at a temperature of 200° C., 45 parts by weight of a polypropylene [melt flow rate (MFR): 0.35 gram per 10 minutes], 55 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), 1 part by weight of stearic acid monoglyceride, and 1 part by weight of a fatty acid bisamide (erucamide). The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 50 μm and an apparent density of 0.03 g/cm³.

### Example 3

In a twin-screw kneader supplied by The Japan Steel Works, LTD. (JSW) were kneaded, at a temperature of 200° C., 47 parts by weight of a polypropylene [melt flow rate (MFR): 0.35 gram per 10 minutes], 53 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), 1 part by weight of stearic acid monoglyceride, and 1 part by weight of a fatty acid bisamide (lauric acid bisamide). The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 60 μm and an apparent density of 0.03 g/cm³.

### Example 4

In a twin-screw kneader supplied by The Japan Steel Works, LTD. (JSW) were kneaded, at a temperature of 200° C., 45 parts by weight of a polypropylene [melt flow rate (MFR): 0.35 gram per 10 minutes], 55 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), 1 part by weight of stearic acid monoglyceride, and 2 parts by weight of a fatty acid bisamide (lauric acid bisamide). The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 30 μm and an apparent density of 0.04 g/cm³.

### Comparative Example 1

In a twin-screw kneader supplied by The Japan Steel Works, LTD. (JSW) were kneaded, at a temperature of 200° C., 45 parts by weight of a polypropylene [melt flow rate (MFR): 0.35 gram per 10 minutes], 55 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), and 1 part by weight of stearic acid monoglyceride. The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 70 μm and an apparent density of 0.05 g/cm³.

### Comparative Example 2

In a twin-screw kneader supplied by The Japan Steel Works, LTD. (JSW) were kneaded, at a temperature of 200° C., 60 parts by weight of a polypropylene [melt flow rate (MFR): 0.35 gram per 10 minutes], 40 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), and 1 part by weight of stearic acid monoglyceride. The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 80 μm and an apparent density of 0.03 g/cm³.

### Comparative Example 3

In a twin-screw kneader supplied by The Japan Steel Works, LTD. (JSW) were kneaded, at a temperature of 200° C., 50 parts by weight of a polypropylene [melt flow rate (MFR): 0.35 gram per 10 minutes], 50 parts by weight of a polyolefin elastomer [melt flow rate (MFR): 6 grams per 10 minutes, JIS A hardness: 79°], 10 parts by weight of magnesium hydroxide, 10 parts by weight of a carbon product (trade name “Asahi #35” supplied by Asahi Carbon Co., Ltd.), 1 part by weight of stearic acid monoglyceride, and 2 parts by weight of a fatty amide (erucamide). The kneadate was extruded into strands, cooled with water, and formed into pellets. The pellets were charged into a single-screw extruder supplied by The Japan Steel Works, LTD., and carbon dioxide gas was injected at an atmospheric temperature of 220° C. and at a pressure of 13 MPa, where the pressure became 12 MPa after injection. The carbon dioxide gas was injected in a proportion of 6 percent by weight relative to the total weight of the polymers. After the carbon dioxide gas was sufficiently saturated, the article was cooled to a temperature suitable for foaming (expansion), extruded through a die, and thereby yielded a foam. The foam had an average cell diameter of 150 μm and an apparent density of 0.03 g/cm³.

### (Evaluations)

The dustproofness of the foams according to the examples and comparative examples was evaluated by the “method for measuring dustproofness index” mentioned below. Independently, the hermeticity (air-tightness) of the foams was evaluated by measuring a differential pressure (differential pressure upon compression by 30%) between inside and outside of the foam, and the loads against repulsion upon compression to 0.1 mm (repulsive stress upon compression to 0.1 mm) of the foams were also measured. In addition, the tensile strengths and Young's moduli of elasticity of the foams according to the examples and comparative examples were also measured. The results of these evaluations or measurements are shown in Table 1.

### (Method for Measuring Differential Pressure Between Inside and Outside of Foam)

The foams according to the examples and comparative examples were punched into frame-shaped test pieces. The frame-shaped test pieces were square and had a thickness of 0.3 mm, a frame width of 4 mm, and a length of one outer side of 56 mm with a square opening having a length of one side of 52 mm. The frame-shaped test pieces were compressed by 30%, and the differential pressures (differential pressures upon compression by 30%) between outside and inside of the foams were measured.

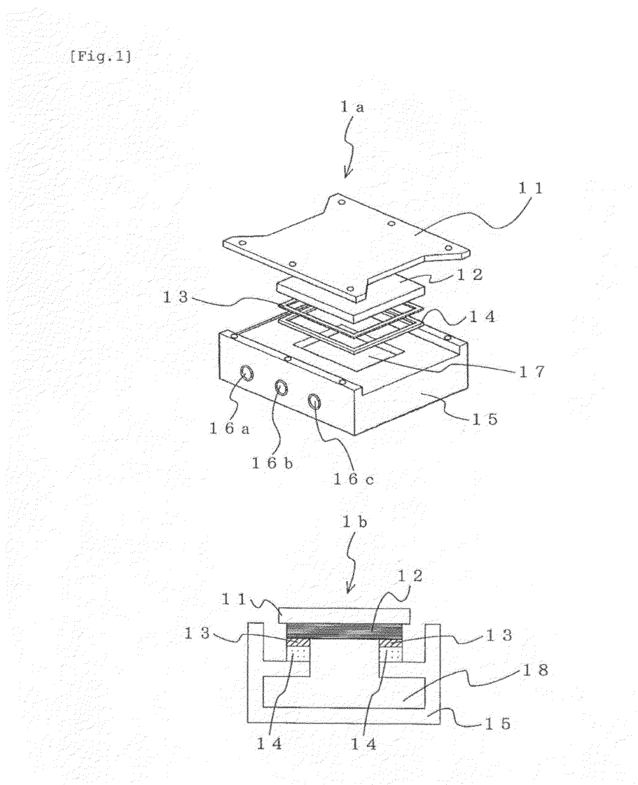

The differential pressures were measured by using a dustproofness-testing apparatus illustrated in FIG. 1. In FIG. 1, the view 1a shows a schematic structure of the dustproofness-testing apparatus; the view 1b shows a schematic sectional structure of the dustproofness-testing apparatus; the reference numerals “11” stands for a ceiling panel; “12” stands for a spacer; “13” stands for a double-sided pressure-sensitive adhesive tape (frame-shaped double-sided pressure-sensitive adhesive tape, carrier-less type, thickness: 80 μm); “14” stands for a foam (foam according to the examples and comparative examples, which has been punched into a frame shape); “15” stands for a testing box; “16a” stands for a through hole which is connected via a pipe joint to a metering pump; “16b” stands for a through hole which is connected via a pipe joint to a differential pressure gauge; “16c” stands for a through hole which is connected via a pipe joint to a needle valve; “17” stands for an opening (a square having a length of one side of 52 mm); and “18” stands for a space. The dustproofness-testing apparatus can have the space 18 inside thereof, by screwing the ceiling panel 11 with the testing box 15, in which the ceiling panel 11 is a substantially rectangular plate. The space 18 is in a substantially rectangular parallelepiped form and can be hermetically sealed. The opening 17 is an opening of the space 18. The ceiling panel 11 has cuts which constitute openings, whose plan views are rectangular (trapezoidal).

The spacer 12 is mounted below the underside of the ceiling panel 11 facing the opening 17 so that the spacer 12 faces the overall of the opening 17. The spacer 12 is larger than the opening 17 and has a rectangular plate form. The foam 14 is mounted via the double-sided pressure-sensitive adhesive tape 13 to a position of the underside of the spacer 12 facing the opening 17. The foam 14 has a window having a size substantially the same as that of the opening 17. When the ceiling panel 11 is screwed, the foam 14 is therefore compressed in a thickness direction by the peripheries of the spacer 12 and of the opening 17. The compression ratio of the foam 14 was controlled to 30% (compression by 30%) by adjusting the thickness of the spacer 12.

When the ceiling panel 11 and the testing box 15 are screwed with each other, the space 18 in the testing box 15 is hermetically sealed by the foam 14, double-sided pressure-sensitive adhesive tape 13, and spacer 12.

The dustproofness of a sample foam was determined using the dustproofness-testing apparatus. Specifically, the foam was compressed by a compression ratio of 30%; a metering pump was connected via a pipe joint to the through hole 16a; a differential pressure gauge was connected via a pipe joint to the through hole 16b; a needle valve was connected via a pipe joint to the through hole 16c; aspiration by the metering pump was performed at an aspiration rate of 0.5 liters per minute while keeping the needle valve closed; and a differential pressure was measured with the differential pressure gauge.

(Method for Measuring Dustproofness Index)

The foams according to the examples and comparative examples were punched into frame-shaped test pieces. The frame-shaped test pieces were square and had a thickness of 0.3 mm, a frame width of 4 mm, and a length of one outer side of 56 mm with a square opening having a length of one side of 52 mm. The frame-shaped test pieces were subjected to testing in the dustproofness-testing apparatus, and the proportions of passed particles having diameters of 0.5 μm or more [dustproofness index (%)] were determined.

Specifically, each of the frame-shaped test pieces obtained from the foams according to the examples and comparative examples was set in the dustproofness-testing apparatus at a compression ratio of 30% in the same manner as in “Method for Measuring Differential Pressure Between Inside and Outside of Foam”. The dustproofness-testing apparatus housing the frame-shaped test piece was placed in a dust box, and the dust box was hermetically sealed. In this testing, the through hole 16b was connected via a pipe joint to a particle counter.

Next, a number P₀ of particles in the atmosphere was determined while controlling the count (number) of particles having diameters of 0.5 μm or more in the dust box to be substantially constant at around 100000 by using a dust supply unit and a particle counter both connected to the dust box.

Next, aspiration by the metering pump from the through hole 16a was performed at an aspiration rate of 0.5 liter per minute for 30 minutes while keeping the needle valve of the through hole 16c closed. After the aspiration, the number of particles having diameters of 0.5 μm or more in the space 18 of the dustproofness-testing apparatus was measured with the particle counter to thereby determine a number P_{f} of particles passing through the foam.

The dustproofness index (%) was then determined according to the following equation:

Dustproofness Index(%)=(P₀−P_{f})/P₀×100

wherein P₀ represents the number of particles in the atmosphere; and P_{f} represents the number of particles passing through the foam.

(Load Against Repulsion Upon Compression to a Thickness of 0.1 mm)

The load against repulsion upon compression to a thickness of 0.1 mm was measured in accordance with the method for measuring compressive hardness of a form specified in Japanese Industrial Standards (JIS) K 6767. Specifically, a foam having such a smallest thickness as to have a dustproofness index of 100% (i.e., particles having diameters of 0.5 μm or more did not pass through the foam) was cut into a round test piece 20 mm in diameter; the test piece was compressed at a compression rate of 2.54 mm per minute to a thickness of 0.1 mm; the stress (newton; N) upon the compression was measured, and the measured stress was converted into a stress per unit area (1 m²) and this was defined as the load against repulsion upon compression to a thickness of 0.1 mm (repulsive stress upon compression to a thickness of 0.1 mm) (Pa).

The thicknesses of the foams having dustproofness indices of 100% were 0.3 mm in Examples 1 to 4 and 0.5 mm in Comparative Examples 1 to 3, respectively.

(Tensile Strength)

The foams according to the examples and comparative examples were processed into test pieces 0.3 mm thick, and the tensile strengths (MPa) of the test pieces were measured in accordance with the method relating to “Tensile Strength” specified in JIS K 6767.

(Young's Modulus of Elasticity)

The foams according to the examples and comparative examples were processed into test pieces 0.3 mm thick, and the Young's moduli of elasticity (N/cm²) of the test pieces were measured in accordance with JIS K 7127.

(Method for Evaluating Fittability in Clearance)

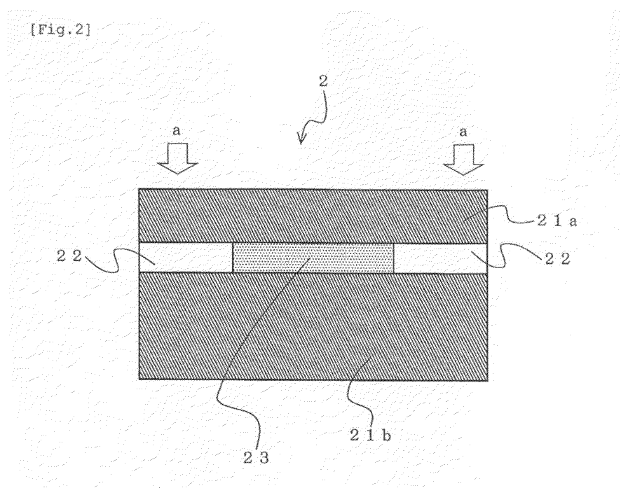

Each of the foams according to the examples and comparative examples was set in a jig shown in FIG. 2, and how the upper acrylic plate deformed was visually observed. Specifically, spacers each 0.1 mm thick were placed at both lateral ends of an acrylic plate 20 mm thick; a sample foam was placed at a center part sandwiched between the spacers; an acrylic plate 10 mm thick was arranged on the top face of the foam and spacers; a load was applied to the upper acrylic plate (10 mm thick) in portions facing the spacers at both lateral ends to thereby compress the foam; and whether the upper acrylic plate deformed was visually observed. A sample which caused no deformation was evaluated as having good fittability in clearance (Good), and a sample which caused deformation was evaluated as having poor fittability in clearance (Poor).

The test pieces of the foams according to the examples and comparative examples were controlled to have such a thickness as to give a dustproofness index of 100%. Accordingly, the test pieces had thicknesses of 0.3 mm in the foams according to Examples 1 to 4 and had thicknesses of 0.5 mm in the foams according to Comparative Examples 1 to 3.

(180-Degree Peel Force)

The materials (foams) to be measured were stored at an atmospheric temperature of 23±2° C. and relative humidity of 50±5% for 24 hours or longer (pretreatment under conditions with reference to JIS Z 0237) and thereafter cut to pieces 30 mm wide and 120 mm long. A single-sided pressure-sensitive adhesive tape (trade name “No. 31C” supplied by Nitto Denko Corporation) or carrier tape (trade name “ECT 755” supplied by Nitto Denko Corporation) each 20 mm wide and 120 mm long was affixed to each of the cut pieces of foams through compression bonding by one reciprocating movement of a 2-kg roller, the resulting articles were left stand for 30 minutes and thereby yielded evaluation samples (samples for the evaluation of peel force from single-sided pressure-sensitive adhesive tape, or samples for the evaluation of peel force from carrier tape).

Next, the surface of the foam of each of the evaluation samples was affixed to a backing plate (a bakelite plate 2 mm thick, supplied by Sumitomo Bakelite Co., Ltd.) through a double-sided pressure-sensitive adhesive tape (trade name “No. 500” supplied by Nitto Denko Corporation). The double-sided pressure-sensitive adhesive tape was highly adhesive so as to prevent lifting (pop-off) and peeling of the surface of the foam from the backing plate.

The force required to peel the single-sided pressure-sensitive adhesive sheet or carrier tape from the foam was measured at a peel angle of 180 degrees to evaluate the 180-degree peel force (to evaluate adhesion).

Evaluations on the samples for the evaluation of peel force from single-sided pressure-sensitive adhesive tape (evaluations of the adhesive strength of the single-sided adhesive tape) were performed by measuring the 180-degree peel force at a tensile speed of 300 mm per minute using a universal tensile and compression testing machine (trade name “TCM-1kNB” supplied by Minebea Co., Ltd.).

Evaluations on the samples for the evaluation of peel force from carrier tape (evaluations of the adhesive strength of the carrier tape) were performed by measuring the 180-degree peel force at a tensile speed of 10 meters per minute using a high-speed peeling tester (supplied by Tester Sangyo Co., Ltd.).

TABLE 1

| | Examples | | | | Comparative Examples | | |
|---|---|---|---|---|---|---|---|
| | 1 | 2 | 3 | 4 | 1 | 2 | 3 |
| Average cell diameter | 40 | 50 | 60 | 30 | 70 | 80 | 150 |
| (μm) | | | | | | | |
| Apparent density | 0.03 | 0.03 | 0.03 | 0.04 | 0.05 | 0.03 | 0.03 |
| (g/cm³) | | | | | | | |
| Differential pressure upon compression by 30% | 4.0 | 4.0 | 3.7 | 4.2 | 3.5 | 2.7 | 2.3 |
| (KPa) | | | | | | | |
| Repulsive stress upon compression to a thickness of 0.1 mm | 0.02 | 0.02 | 0.02 | 0.02 | 0.05 | 0.06 | 0.06 |
| (MPa) | | | | | | | |
| Dustproofness index (%) | | | | | | | |
| 0.3 mm thick | 100 | 100 | 100 | 100 | 99.5 | 97.5 | 96.4 |
| 0.5 mm thick | 100 | 100 | 100 | 100 | 100 | 100 | 100 |
| Tensile strength | 0.4 | 0.4 | 0.4 | 0.5 | 0.2 | 0.3 | 0.2 |
| (MPa) | | | | | | | |
| Young's modulus of elasticity | 150 | 140 | 130 | 160 | 60 | 100 | 90 |
| (N/cm²) | | | | | | | |
| Fittability in clearance | Good | Good | Good | Good | Poor | Poor | Poor |
| 180-Degree peel force (N/20 mm) | | | | | | | |
| Single-sided pressure-sensitive adhesive tape | 2.97 | 2.83 | 2.67 | 3.08 | 1.73 | 0.61 | 0.36 |
| Carrier tape | 0.54 | 0.53 | 0.51 | 0.55 | 0.38 | 0.25 | 0.18 |

Table 1 demonstrates that the foams according to the examples exhibit superior dustproofness when compressed to 0.1 mm. The foams also exhibit satisfactory flexibility even when those having a thickness of 0.3 mm are compressed to a thickness of 0.1 mm. Accordingly, the foams do not cause deformation of an optical member even when the optical member is affixed to a predetermined site through them and the clearance between the optical member and the predetermined site is very narrow (typically of about 0.1 mm). In addition, the foams according to the examples are improved in tensile strength as compared to the foams according to the comparative examples and thereby do not cause breakage and/or tearing of the foams typically upon mounting to a predetermined site.

The foams according to the examples have higher 180-degree peel force than that of the foams according to the comparative examples and can thereby save a heat treatment step or another step typically when a slightly adhesive single-sided pressure-sensitive adhesive tape is affixed thereto. In addition, the foams, when applied to carrier tapes for foam members, can prevent dislocation (slippage) from the carrier tapes during conveyance or during punching.

### INDUSTRIAL APPLICABILITY

The foam dustproofing materials according to embodiments of the present invention have superior dustproofness and can satisfactorily fit even in a minute clearance. The foam dustproofing materials are useful as dustproofing materials for use in mounting of various members or parts to predetermined sites.

1. A foam dustproofing material comprising a foam having a thickness of from 0.1 to 1.0 mm, wherein the foam has a micro cell structure with an average cell diameter of from 10 to 65 μm, has such characteristic properties as to give a load against repulsion of from 0.010 to 0.100 MPa upon compression to a thickness of 0.1 mm, and has an apparent density of from 0.01 to 0.050 g/cm³.

2. The foam dustproofing material according to claim 1, wherein the foam has an average cell diameter of from 10 to 50 μm.

3. The foam dustproofing material according to claim 1, wherein the foam has a closed cell structure or semi-open/semi-closed cell structure.

4. The foam dustproofing material according to claim 1, further comprising a pressure-sensitive adhesive layer present on or above one or both sides of the foam.

5. The foam dustproofing material according to claim 4, wherein the pressure-sensitive adhesive layer is present above one or both sides of the foam with the interposition of a film layer.

6. The foam dustproofing material according to claim 4, wherein the pressure-sensitive adhesive layer comprises an acrylic pressure-sensitive adhesive.

7. The foam dustproofing material according to claim 1, wherein the foam is prepared through the steps of impregnating a thermoplastic polymer with a high-pressure inert gas; and subjecting the impregnated thermoplastic polymer to decompression.

8. The foam dustproofing material according to claim 7, wherein the foam is prepared through the steps of impregnating an unfoamed molded article with a high-pressure inert gas, the unfoamed molded article including a thermoplastic polymer; and subjecting the impregnated unfoamed molded article to decompression.

9. The foam dustproofing material according to claim 7, wherein the foam is prepared through the steps of impregnating a molten thermoplastic polymer with an inert gas under a pressure (under a load); and subjecting the impregnated molten thermoplastic polymer simultaneously to decompression and molding.

10. The foam dustproofing material according to claim 7, wherein the foam is prepared further through the step of heating performed after the decompression.

11. The foam dustproofing material according to claim 7, wherein the inert gas is carbon dioxide.

12. The foam dustproofing material according to claim 7, wherein the inert gas is in a supercritical state during impregnation.

13. A foam dustproofing material comprising a sliced piece of the foam dustproofing material according to claim 1 and has a thickness of from 0.2 to 0.4 mm.

14. The foam dustproofing material according to claim 2, wherein the foam is prepared through the steps of impregnating a thermoplastic polymer with a high-pressure inert gas; and subjecting the impregnated thermoplastic polymer to decompression.

15. The foam dustproofing material according to claim 3, wherein the foam is prepared through the steps of impregnating a thermoplastic polymer with a high-pressure inert gas; and subjecting the impregnated thermoplastic polymer to decompression.

16. The foam dustproofing material according to claim 4, wherein the foam is prepared through the steps of impregnating a thermoplastic polymer with a high-pressure inert gas; and subjecting the impregnated thermoplastic polymer to decompression.

17. The foam dustproofing material according to claim 5, wherein the foam is prepared through the steps of impregnating a thermoplastic polymer with a high-pressure inert gas; and subjecting the impregnated thermoplastic polymer to decompression.

18. The foam dustproofing material according to claim 6, wherein the foam is prepared through the steps of impregnating a thermoplastic polymer with a high-pressure inert gas; and subjecting the impregnated thermoplastic polymer to decompression.

19. The foam dustproofing material according to claim 14, wherein the foam is prepared through the steps of impregnating an unfoamed molded article with a high-pressure inert gas, the unfoamed molded article including a thermoplastic polymer; and subjecting the impregnated unfoamed molded article to decompression.

20. The foam dustproofing material according to claim 14, wherein the foam is prepared through the steps of impregnating a molten thermoplastic polymer with an inert gas under a pressure (under a load); and subjecting the impregnated molten thermoplastic polymer simultaneously to decompression and molding.
